(19) United States
(12) Patent Application Publication
(10) Pub. No.: US 2020/0404946 A1
(43) Pub. Date: Dec. 31, 2020

(54) EXTRACTS AND THEIR USE

(71) Applicant: SOCIETE DES PRODUITS NESTLE NESTLE S.A., Vevey (CH)

(72) Inventors: Brid Marie Brosnan, Currow - Killarney, Kerry (IE); Jonathan O'Regan, Killarney, Kerry (IE)

(21) Appl. No.: 16/956,674

(22) PCT Filed: Dec. 21, 2018
(86) PCT No.: PCT/EP2018/086664

§ 371 Date: Jun. 22, 2020

(30) Foreign Application Priority Data
Dec. 22, 2017 (EP) 17210389.7

(51) Int. Cl. A23J 1/20; A23L 33/19; A23J 3/08

(52) U.S. Cl. CPC A23J 1/205; A23L 33/40; A23J 3/08; A23L 33/19

(57) ABSTRACT

Use of an α-lactalbumin enriched whey protein extract as a source of osteopontin in a synthetic nutritional composition for an infant or child wherein, the α-lactalbumin enriched WPE is obtained by a process comprising: a. acidifying a whey protein product to pH 4 or below b. forming a low calcium whey protein product by concentrating the proteins in the acidified whey protein until the calcium to protein ratio is less than about 0.001 and, c. Precipitating α-lactalbumin from the low-calcium whey protein product, wherein said precipitating step includes the sub-steps of: X. diluting the low-calcium whey protein product, XI. adjusting the pH of the diluted low-calcium whey protein product to between 4 and 5 to form a precipitate and soluble proteins, and XII. Separating the precipitate proteins from the soluble proteins.

### FIELD OF THE INVENTION

The present invention relates to the use of an α-lactalbumin enriched whey protein extract as a source of osteopontin, and to the use of said α-lactalbumin enriched whey protein extract to optimise the osteopontin concentration in a synthetic nutritional composition for an infant or child. The invention further relates to the use of said synthetic nutritional composition for an infant or child to support and/or optimise growth and development, immune response, galactose metabolism and cytoskeleton remodeling. The invention also relates to a low-protein synthetic nutritional composition for an infant or child comprising the α-lactalbumin enriched whey protein extract.

### BACKGROUND TO THE INVENTION

Breast-feeding is recommended for all infants. However, in some cases breast-feeding is insufficient or not possible for medical reasons. In these situations infant formula can be used as a substitute for breast milk. However, studies have shown that the composition of infant formula is not identical to that of breast-milk, and that it may not always have identical effects on the body. In light of this, and in light of the fact that breast-milk is considered the gold standard when it comes to infant nutrition, a goal of infant formula manufacturers is to further develop the compositions of their infant formulas and growing-up milks and to bring them closer to breast milk.

Mammalian milk, in particular cow milk, is typically used as basis for synthetic infant formula and growing-up milks. Such milks however differ from human milk for example in the content of specific proteins having a beneficial effect on the infant or child. Examples of such proteins include for example osteopontin, α-lactalbumin, lactoferrin, among others.

The amount of osteopontin in breast-milk is present in an amount far exceeding that in infant formula. This can result in formula-fed infants having a lower osteopontin intake which may have negative effects on their growth and development, immune response, galactose metabolism and cytoskeleton remodeling. In an effort to address this gap, infant formula manufacturers have aimed to increase the concentration of osteopontin in their infant formulas. However, this can pose a challenge. Dairy sources used in infant formula to provide osteopontin, e.g. whey protein or extracts thereof, often only comprise osteopontin in low concentrations, and this makes it impossible to use them in infant formula in the concentrations required to supply a sufficient amount of osteopontin without providing an excess of another ingredient, such as protein, and/or without having to reduce the quantities of other important nutrients in the infant formula composition. Whilst sources of pure or essentially pure osteopontin are available, these are often unsuitable for use in infant formula.

It is also desirable to be able to find ingredients providing significant amounts of osteopontin, while also providing a source of other beneficial proteins that are typically in low amounts in infant formula, such as those mentioned above.

Accordingly, there is a need to identify ingredients that can be used in infant formulas as a source of osteopontin that do not suffer from one or more of the drawback listed above.

Surprisingly, the inventors have now found that a whey protein extract that has been processed to increase the α-lactalbumin content by use of a particular process detailed herein (hereinafter an α-lactalbumin enriched WPE), comprises osteopontin in a concentration far higher than that found in other whey protein extracts that have been processed to enrich the α-lactalbumin content by using other methods. This advantageously enables this particular α-lactalbumin enriched whey protein extract to be used as a source of osteopontin and to optimise the concentration of osteopontin in a composition for an infant or child, while at the same time also providing a source of α-lactalbumin. In the absence of an ingredient having both an enriched content of osteopontin and of α-lactalbumin, it would be required to add two different ingredients in order to add these two proteins into an infant formula. As osteopontin and α-lactalbumin are typically provided in the form of ingredients comprising significant amounts of additional milk protein, such as whey, the protein content in the infant formula in which two separate ingredient have been added would have a significantly higher protein content compared to a formula in which the present α-lactalbumin enriched whey protein extract is used. Thus, the present α-lactalbumin enriched whey protein extract is particularly useful in infant formula intended to have a low protein content.

### SUMMARY OF THE INVENTION

The invention is set out in the claims and in further detail in the detailed description included herein.

The present invention encompasses the use of an α-lactalbumin enriched whey protein extract as a source of osteopontin in a synthetic nutritional composition for an infant or child wherein, the α-lactalbumin enriched WPE is obtained by a process comprising:
a. acidifying a whey protein product to pH 4 or below,
b. forming a low calcium whey protein product by concentrating the proteins in the acidified whey protein until the calcium to protein ratio is less than about 0.001 and,
c. Precipitating α-lactalbumin from the low-calcium whey protein product, wherein said precipitating step includes the sub-steps of:
   I. diluting the low-calcium whey protein product,
   II. adjusting the pH of the diluted low-calcium whey protein product to between 4 and 5 to form a precipitate and soluble proteins, and
   III. Separating the precipitate proteins from the soluble proteins.

An “α-lactalbumin enriched WPE” is herein defined as a whey protein extract that has been processed to increase the amount of α-lactalbumin in the whey protein extract compared to the un-processed whey protein extract.

The α-lactalbumin enriched WPE obtained by the specific process described herein has been found to be surprisingly rich in osteopontin and may advantageously be used to optimise the osteopontin concentration in a synthetic nutritional composition for an infant or child. The α-lactalbumin enriched whey protein extract may be added to a synthetic nutritional composition in an effective amount, sufficient to ensure that the said composition has a final concentration of osteopontin in a range found in human breast milk.

The α-lactalbumin enriched WPE is also a rich source of α-lactalbumin. Because of this, it may also be used to optimise the concentration of α-lactalbumin in said synthetic nutritional composition for an infant or child, and may be added to said composition in an effective amount sufficient to provide α-lactalbumin in one of the ranges found in human breast milk.

The invention also provides a synthetic nutritional composition comprising the α-lactalbumin enriched WPE, obtained as detailed herein, in a concentration of 0.8 to 8 g/L. A composition may for example comprise 4 to 5 g/L of the α-lactalbumin enriched WPE and may be formulated for an infant of 6 to 12 months of age, or may be formulated for an child of 12 to 36 months of age. A composition may for example comprise 0.5 to 3 g/L, preferably 0.5 to 2.7 g/L of the α-lactalbumin enriched WPE and may be formulated for a child of 3 to 8 years of age. The osteopontin concentration in said compositions may be at least 57 mg/L.

The synthetic nutritional composition for an infant or child may be a composition for consumption by infants either alone or in combination with human breast milk, and may be an infant formula or human breast milk fortifier.

The α-lactalbumin enriched WPE obtained as described herein, or a synthetic nutritional composition comprising it, may be used to provide an infant or child with an optimized amount of osteopontin, it may also be used to support and/or optimise the growth and/or development of an infant or child, to support and/or optimise the immune response of an infant or child, in the treatment and/or prevention of sub-optimal immune response of an infant or child, in the treatment and/or prevention of sub-optimal growth of an infant or child.

It is particularly useful to have osteopontin provided as part as α-lactalbumin enriched WPE as described herein, because both α-lactalbumin and osteopontin may be used to support and/or optimise the growth of an infant or child, or in the treatment or prevention of sub-optimal growth of an infant or child.

The invention will now be described in further detail.

### DETAILED DESCRIPTION

In a first aspect of the present invention there is provided the use of an α-lactalbumin enriched WPE as a source of osteopontin in a synthetic nutritional composition for an infant or child wherein, said α-lactalbumin enriched WPE is obtained by a process comprising:
a. acidifying a whey protein product to pH 4 or below for example a pH in the rage 3.3 to 3.8 such as pH 3.5,
b. forming a low calcium whey protein product by concentrating the proteins in the acidified whey protein until the calcium to protein ratio is less than about 0.001 for example by ultrafiltration e.g. through a 10K-100K molecular weight cut off membrane, and/or diafiltration, and
c. Precipitating α-lactalbumin from the low-calcium whey protein product, wherein said precipitating step includes the sub-steps of:
   IV. diluting the low-calcium whey protein product,
   V. adjusting the pH of the diluted low-calcium whey protein product to between 4 and 5 to form a precipitate and soluble proteins, and
   VI. Separating the precipitate proteins from the soluble proteins for example by ultrafiltration e.g. through a 5K-50K molecular weight cut off membrane, and/or by diafiltration.

In step a, the whey protein product may be acidified by the addition of an acid. The acid may be a food grade acid e.g. hydrochloric acid, phosphoric acid, citric acid, and/or sulfuric acid. If a whey protein powder is used as the whey protein product, this must be brought into solution prior to step a.

The whey protein product may be a whey protein concentrate prepared in any conventional way from mammalian whey (sweet or acid whey) for example cow, goat, sheep, buffalo, water buffalo, yak, human, camel and/or llama. A whey protein concentrate may for example be obtained from skimmed and/or clarified bovine whey that has been concentrated and/or desalted by common means, e.g. by ultrafiltration (the whey protein product may be the retentate) and/or diafiltration.

A process for obtaining an α-lactalbumin enriched WPE for use in the invention detailed herein is described in U.S. Pat. No. 6,312,755, the contents of which is hereby incorporated by reference.

Accordingly in an embodiment of the present invention the α-lactalbumin enriched WPE is rich in osteopontin and comprises at least 4 g, preferably at least 4.5 g, more preferably at least 5 g, even more preferably at least 5.5 g and most preferably 5.7 g of osteopontin per 100 g. In a preferred aspect of the invention, the amount of osteopontin is determined in accordance with the method described in Example 1 below.

The term “osteopontin” as used herein preferably refers to bovine or human osteopontin, such as characterized in Christensen et al.; Structure, function and nutritional potential of milk osteopontin; International Dairy Journal 57 (2016): 1-6. Posttranslational modifications of bovine osteopontin: Identification of twenty-eight phosphorylation and three O-glycosylations sites.

The α-lactalbumin enriched WPE is particularly suitable for use as a source of osteopontin in a synthetic nutritional composition for an infant or child e.g. an infant formula or composition for consumption by an infant or child either alone or in combination with human breast milk. As previously stated herein, it is known that the osteopontin concentration can differ between breast milk and infant formula; given the positive wellness effects associated with an adequate osteopontin intake, there is a need to optimise the osteopontin concentration in said compositions.

In another aspect of the present invention there is provided the use of an α-lactalbumin enriched WPE to optimise the osteopontin concentration of a synthetic nutritional composition for an infant or child wherein said α-lactalbumin enriched WPE is obtained by a process as detailed herein.

The α-lactalbumin enriched WPE may be added to a synthetic nutritional composition in any amount effective (an effective amount) to optimise the concentration of osteopontin in said synthetic nutritional composition for an infant or child.

Given that human breast milk is the gold standard when it comes to infant and/or child nutrition, the concentration of osteopontin in a synthetic nutritional composition for an infant or child may be considered optimised if the concentration of osteopontin is within a range, or above a range, found in human breast milk.

Osteopontin has been found to be present in breast milk in a concentration range of about 10 to 350 mg/L, and in particular in a concentration range of 18 to 322 mg/L.

Accordingly, an effective amount of the α-lactalbumin enriched WPE maybe an amount sufficient to provide osteopontin in one or more of these ranges or in a higher concentration. An effective amount may also be an amount sufficient to ensure that the synthetic nutritional composition has a final concentration of osteopontin in one or more of these ranges or in a higher concentration when considering other ingredients comprised in the composition that comprise osteopontin e.g. dairy ingredients such as skimmed milk powder and whey protein. Said ingredients may comprise osteopontin innately.

It is well within the purview of the person skilled in the art to determine an effective amount of the α-lactalbumin enriched WPE, to be added to the synthetic nutritional composition for an infant or child, based upon the amount of osteopontin found in human breast milk and the concentration of osteopontin in the α-lactalbumin enriched WPE, and when applicable the concentration of osteopontin coming from other ingredients comprised in the synthetic nutritional composition for an infant or child.

The optimised concentration of osteopontin may be the concentration of osteopontin in the synthetic nutritional composition upon reconstitution for example with milk or water. It is well within the purview of the skilled person to determine an effective amount taking into consideration the concentration of osteopontin in the α-lactalbumin enriched WPE and when appropriate reconstitution instructions for the synthetic nutritional composition.

A particular advantage of the α-lactalbumin enriched WPE used in the invention is that it can provide an optimised amount of osteopontin to a synthetic nutritional composition for an infant or child and negate the need to add additional ingredients for this purpose, for example additional ingredients whose addition would be for the sole or primary purpose of increasing the osteopontin concentration e.g. isolated osteopontin. Accordingly, in an embodiment the α-lactalbumin enriched WPE is not used in combination with an additional ingredient whose sole or primary purpose would be to increase the osteopontin concentration in the synthetic nutritional composition, for example it is not used in combination with isolated osteopontin.

The term “infant” as used herein refers to a human infant of up to 12 months of age and includes preterm and very preterm born infants, infants having a low birth weight i.e. a new born having a body weight below 2500 g (5.5 pounds) either because of preterm birth or restricted fetal growth, and infants born small for gestational age (SGA) i.e. babies with birth weights below the 10th percentile for babies of the same gestational age.

The term “child” as used herein refers to a human of 1 to 18 years of age, for example a human of 1 to 8 years of age, a human of 1 to 3 years of age, and/or a human of 1 to 2 years of age.

A “preterm” or “premature” means an infant or young child that was not born at term. Generally it refers to an infant born prior to the completion of 37 weeks of gestation.

The α-lactalbumin enriched WPE formed by the process described herein also serves as a source of protein for example α-lactalbumin, β-lactoglobulin, lactoferrin and immunoglobulins.

The α-lactalbumin enriched WPE obtained by this process set out hereinabove comprises α-lactalbumin in a concentration in the range of about 28% to 40% of the total protein, for example about 28% to 36% of total protein, and β-lactoglobulin in a concentration in the range of about 8% to about 33% of the total protein, for example 10% to about 29% of total protein. The percentage of α-lactalbumin in the α-lactalbumin enriched WPE is greater than the percentage of β-lactoglobulin, for example the β-lactoglobulin concentration is not greater than the percentage of the α-lactalbumin content minus 7%.

All percentages disclosed herein with respect to the α-lactalbumin enriched WPE are on a w/w basis unless stated otherwise.

A particular advantage of the α-lactalbumin enriched WPE used in the invention is that its osteopontin and α-lactalbumin concentrations are such that it is possible to optimise the osteopontin concentration in a synthetic nutritional composition for an infant or child at the same time as optimising the α-lactalbumin concentration.

α-lactalbumin is the dominant whey protein found in human breast milk with a concentration of 1.6-3.8 g/L, it is a protein that is rich in essential amino acids, and is believed to be important for optimum growth and development in infants and children, and is thought to play a role in gastrointestinal (GI) health, reducing for example constipation, reflux and vomiting.

In an embodiment of the invention the α-lactalbumin enriched WPE is simultaneously used to optimise the concentration of osteopontin and to optimise the concentration of α-lactalbumin in a synthetic nutritional composition for an infant or child.

The term “optimised concentration of α-lactalbumin” as used herein refers to a concentration of α-lactalbumin that is within a range found in human breast milk (1.6-3.8 g/L). The α-lactalbumin enriched WPE may be considered to optimise the concentration of α-lactalbumin in a synthetic nutritional composition if the α-lactalbumin concentration for the synthetic nutritional composition is within the range found in human breast milk, when considering other ingredients comprised in the composition that comprise α-lactalbumin e.g. dairy ingredients such as skimmed milk powder and whey protein. Said ingredients may comprise α-lactalbumin innately.

It is well within the purview of the person skilled in the art to determine an effective amount of the α-lactalbumin enriched WPE, to be added to the synthetic nutritional composition for an infant or child, based upon the amount of osteopontin and α-lactalbumin found in human breast milk and the concentration of osteopontin and α-lactalbumin in the α-lactalbumin enriched WPE, and when applicable the concentration of osteopontin and/or α-lactalbumin coming from other ingredients comprised in the synthetic nutritional composition for an infant or child e.g. skimmed milk powder.

The optimised concentrations of osteopontin and α-lactalbumin may be the concentrations of osteopontin and α-lactalbumin in the synthetic nutritional composition upon reconstitution for example with milk or water. It is well within the purview of the skilled person to determine an effective amount taking into consideration the concentration of osteopontin and α-lactalbumin in the α-lactalbumin enriched WPE, and when appropriate reconstitution instructions for the synthetic nutritional composition.

The α-lactalbumin enriched WPE may for example be used in an amount sufficient to provide 1 g to 1.2 g of protein per 100 available kilocalories equating to 0.28 to 0.48 g of α-lactalbumin per 100 available kilocalories or 1.88 to 3.23 g of α-lactalbumin/L and 28 to 131 mg/L of osteopontin/L.

In another aspect of the present invention there is provided a synthetic nutritional composition for an infant or child comprising an α-lactalbumin enriched whey protein extract obtained as disclosed herein.

In an embodiment the synthetic nutritional composition comprises the α-lactalbumin enriched WPE in a concentration within a range of 0.8 to 10 g/L for example 0.8 to 8, 0.8 to 5 g/L, 0.85 to 4.5 g/L, 3 to 4.5 g/L.

In an embodiment at least 10% of the total osteopontin in the synthetic nutritional composition comes from the α-lactalbumin enriched WPE for example 10 to 100%, 49% to 100%, 49% to 70%.

The synthetic nutritional composition comprises osteopontin in a concentration in a range as in human breast milk or in a higher concentration. Accordingly, the synthetic nutritional composition may comprise osteopontin in a concentration of 10 mg/L or more, for example from 10 to 400 mg/L, from 10 to 350 mg/L, from 10 to 325 mg/L or from 10 to 322 mg/L.

In another embodiment of the present invention the composition also comprises alpha lactalbumin in a concentration within a range found in human breast milk for example in a range of 1.6 to 3.8 g/L, for example 1.7 to 3 g/L.

A goal of infant formula manufacturers is to mimic the composition of human breast milk. However, the composition of human breast milk is extremely dynamic and changes over time. For this reason synthetic nutritional compositions for infants or children are usually stage based with a particular stage being suitable for use in infants or children falling within a particular age range e.g. stage 1 may be aimed at infants of 0 to 6 months, stage 2 may be aimed at infants of 6 months to 12 months, stage 3 may be aimed at children of 12 to 36 months, stage 4 may be aimed at children of 3 to 8 years. Each stage is formulated so that its composition is considered nutritionally sound with respect to the age range of the infant or child to whom it is directed.

In an embodiment of the present invention there is provided a synthetic nutritional composition for an infant or child comprising 9 to 10 g/L of the α-lactalbumin enriched WPE used in the invention for example 9.5-10.2 g/L. In an embodiment said composition is formulated for an infant of 0 to 6 months. In a more specific embodiment the total concentration of osteopontin in said composition is at least 40 mg/L and more specifically in a range of 40 to 150 mg/L, even more specifically in a range of 50 to 131 mg/L.

In another embodiment of the present invention there is provided a synthetic nutritional composition for an infant or child comprising 4 to 5 g/L of the α-lactalbumin enriched WPE used in the invention. In an embodiment said composition is formulated for an infant of 6 to 12 months. In a more specific embodiment the total concentration of osteopontin in said composition is at least 20 mg/L and more specifically in a range of 20 to 110 mg/L, even more specifically in a range of 28 to 103 mg/L.

In another embodiment of the present invention there is provided a synthetic nutritional composition for an infant or child comprising 3 to 4 g/L of the α-lactalbumin enriched WPE used in the invention. In an embodiment said composition is formulated for a child of 12 to 36 months. In a more specific embodiment the total concentration of osteopontin in said composition is at least 25 mg/L and more specifically in a range of 25 to 110 mg/L, even more specifically in a range of 30 to 107 mg/L.

In another embodiment of the present invention there is provided a synthetic nutritional composition for an infant or child comprising 0.5 to 1.5 g/L of the α-lactalbumin enriched WPE used in the invention. In an embodiment said composition is formulated for a child of 3 to 8 years. In a more specific embodiment the total concentration of osteopontin in said composition is at least 30 mg/L and more specifically in a range of 35 to 120 mg/L, even more specifically in a range of 39 to 111 mg/L.

In a preferred embodiment, the synthetic nutritional composition is has a low total protein content. The amount of protein can be as low as adequate for the type of composition and the individual intended to consume it, such as for example according to nutritional requirements and/or regulations. For example the protein content is of at most 20 g/L, preferably at most 18 g/L, more preferably at most 16 g/L, even more preferably at most 15 g/L, even more preferable 14 g/L, even more preferably between 5 and 20 g/L, even more preferably 8 to 18 g/L, even more preferably 10 to 16 g/L, more preferably 11 to 15 g/L, more preferably 12 to 14 g/L, such as for example 13.5 g/L.

The synthetic nutritional composition for an infant or child can also comprise any other ingredients or excipients known to be employed in the type of synthetic nutritional composition in question e.g. infant formula.

Non limiting examples of such ingredients include: other proteins, amino acids, carbohydrates, oligosaccharides, lipids, prebiotics or probiotics, essential fatty acids, nucleotides, nucleosides, vitamins, minerals and other micronutrients.

Other suitable and desirable ingredients of synthetic nutritional compositions, that may be employed in the synthetic nutritional compositions for infants or children are described in guidelines issued by the Codex Alimentarius with respect to the type of synthetic nutritional composition in question e.g. Infant formula, growing up milk, HM fortifier, follow on formula, or food stuffs intended for consumption by infants e.g. complementary foods.

The α-lactalbumin enriched whey protein extract may be added to a synthetic nutritional composition for an infant or child by simply mixing it with other ingredients included in the composition.

Non limiting examples of synthetic nutritional compositions for an infant or child are infant formula, a growing up milk, a composition for infants that is intended to be added or diluted with human breast milk, or a food stuff intended for consumption by an infant and/or child either alone or in combination with human breast milk.

α-lactalbumin is rich in essential and conditionally essential amino acids. Accordingly, the α-lactalbumin enriched WPE of the invention is particularly suitable in low protein synthetic nutritional compositions for infants and children because for a minimal protein intake said infants and children still intake sufficient amino acids to optimise growth and development i.e. be within standard growth curves e.g. WHO standard growth curves.

The α-lactalbumin enriched WPE used in the present invention and obtained by the process described herein contains a minimum amino acid concentration, in grams per 100 grams of total protein, as follows: arginine 3.1; cystine 1.4; histidine 1.6; isoleucine 1.0; leucine 5.3; lysine 3.9; methionine 0.3; phenylalanine 1.2; threonine 3.2; tryptophan 1.5; tyrosine 0.9; and valine 1.0. Accordingly, it may not be necessary to add amino acids to the synthetic nutritional compositions for infants or children when using this α-lactalbumin enriched WPE. The non-protein nitrogen content may be about 15% or less of total nitrogen. The total protein content may be between about 12.5% to about 95% for example 35% to 80% or 73% to 77%. The fat content may be about 15% or less. The ash content may be about 4.5% or less.

In an embodiment the synthetic nutritional composition is a low protein infant formula. A low protein infant formula will comprise less than 3.5 g of protein/100 kcal for example less than 2.5 g/100 kcal or less than 2 g/100 kcal. The low protein infant formula may be an infant formula formulated for an infant of up to 12 months of age, for example for an infant of 0 to 6 months of age, or an infant of 6 to 12 months of age.

The synthetic nutritional compositions for infants or children may be prepared by methods well known in the art for preparing the type of synthetic nutritional composition in question e.g. infant formulae, follow on formulae, a composition for infants that is intended to be added or diluted with HM e.g. HM fortifier, or food stuffs intended for consumption by infants either alone or in combination with HM e.g. complementary foods.

An infant formula may for example be prepared by blending appropriate quantities of the alpha-lactalbumin-enriched whey protein concentrate with skimmed milk, lactose, vegetable oils and fat soluble vitamins in water. These materials may be blended together in quantities sufficient to provide a final concentration of approximately 400 grams/liter. Mineral salts may then be added to the mixture prior to a high temperature/short time pasteurization step. Appropriate mineral salts include calcium chloride, calcium carbonate, sodium citrate, potassium hydroxide, potassium bicarbonate, magnesium chloride, ferrous sulfate, potassium citrate, zinc sulfate, calcium hydroxide, copper sulfate, magnesium sulfate, potassium iodide, sodium selenite, etc. The mixture may then be homogenized and cooled. Heat-labile vitamins and micronutrients may then be added to the mixture. The mixture may then be standardized with deionized water to a final total solids concentration of about 120 to about 135 for example about 123 grams per litre, which is equivalent to about 670 kcal per litre. The formula may then be sterilized using a conventional ultrahigh temperature or standard retort process. This sterilized material may then be placed in appropriate packaging.

In another aspect of the present invention there is provided the use of the α-lactalbumin enriched whey protein extract obtained as disclosed herein to provide an optimised amount of osteopontin to an infant or child. As disclosed herein, said α-lactalbumin enriched whey protein extract may be added to a synthetic nutritional composition in an amount effective to provide an optimised concentration of osteopontin. The α-lactalbumin enriched whey protein extract obtained as disclosed herein may also provide an optimised amount of α-lactalbumin to an infant or child.

Because human breast milk is the gold standard when it comes to infant nutrition, and because the synthetic nutritional compositions comprising the α-lactalbumin enriched whey protein extract disclosed herein may comprise osteopontin in an optimized concentration, they may be used to provide an optimum amount of osteopontin to an infant and thereby to ensure optimum osteopontin levels in an infant or child.

An optimum osteopontin intake has been associated with support and/or optimization of growth and development; immune response; galactose metabolism; and/or cytoskeleton remodeling in an infant or child.

Accordingly, in another aspect of the present invention there is provided a synthetic nutritional composition for an infant or child for use to treat or prevent sub-optimal growth and development, wherein said synthetic nutritional composition comprises an α-lactalbumin enriched whey protein extract obtained as disclosed herein in an amount effective to provide an optimised concentration of osteopontin. The composition may be a composition described herein.

The synthetic nutritional composition may be for use to prevent sub-optimal growth and development in an infant or child having impaired and/or delayed growth and/or development. It is within the purview of the skilled person to assess whether an infant or child is developing normally or whether the infant or child is suffering from impaired or delayed growth and/or development.

In yet another aspect there is provided the use of a synthetic nutritional composition comprising an α-lactalbumin enriched whey protein extract obtained as disclosed herein in an amount effective to provide an optimised concentration of osteopontin to promote and/or optimise immune response in an infant or child to whom it is administered. The composition may be a composition described herein.

In yet another aspect there is provided the use of a synthetic nutritional composition comprising an α-lactalbumin enriched whey protein extract obtained as disclosed herein in an amount effective to provide an optimised concentration of osteopontin to promote and/or optimise galactose metabolism in an infant or child to whom it is administered. The composition may be a composition described herein.

In yet another aspect there is provided the use of a synthetic nutritional composition comprising an α-lactalbumin enriched whey protein extract obtained as disclosed herein in an amount effective to provide an optimised concentration of osteopontin to promote and/or optimise cytoskeleton remodeling in an infant or child to whom it is administered. The composition may be a composition described herein.

As disclosed hereinabove, the the synthetic nutritional compositions comprising the α-lactalbumin enriched whey protein extract disclosed herein may also comprise α-lactalbumin in an optimized concentration. Consequently, they may also be used to provide an optimum amount of α-lactalbumin to an infant or child and thereby also ensure optimum α-lactalbumin levels in an infant or child.

Optimised α-lactalbumin levels have been associated with optimised growth and development in infants and children and gastrointestinal (GI) health reducing for example constipation, reflux and vomiting. Accordingly, said synthetic nutritional compositions may also be used to optimise growth and development and GI health in infants and children, and may be used in the treatment of sub-optimal growth or development and in the treatment of GI disorders e.g. constipation, reflux and/or vomiting.

It should be appreciated that all features of the present invention disclosed herein can be freely combined and that variations and modifications may be made without departing from the scope of the invention as defined in the claims. Furthermore, where known equivalents exist to specific features, such equivalents are incorporated as if specifically referred to in this specification.

There now follows a series of non-limiting examples that serve to illustrate the invention.

### EXAMPLE 1

The amount of osteopontin contained in the ingredients listed in Table 1 was analyzed:

TABLE 1
Samples analysed for their osteopontin content

| Sample | Sample ID | Description | Sample Information |
|---|---|---|---|
| alpha-lac | Sample 1 | Whey protein concentrate enriched | Origin: Nestlé; Batch 1034218 |
| enriched WPE | Sample 2 | in alpha lactalbumin, with 80% | Origin: Nestlé; Batch 1520809 |
| | Sample 3 | protein. | Origin: Nestlé; Batch 1033987 |
| | Sample 4 | | Origin: Nestlé; Batch 1040645 |
| | Sample 5 | | Origin: Nestlé; Batch 1036487 |
| | Sample 6 | | Origin: Nestlé; Batch 1034911 |
| | Sample 7 | | Origin: Nestlé; Batch 1036482 |
| | Sample 8 | | Origin: Nestlé; Batch 1033987 |
| | Sample 9 | | Origin: Nestlé; Batch 1033986 |
| | Sample 10 | | Origin: Nestlé; Batch 1001551 |
| | Sample 11-14 | | Origin: Nestlé; Batch 1162581 |
| | Sample 15-18 | | Origin: Nestlé; Batch 1160690 |
| | Sample 19-22 | | Origin: Nestlé; Batch 1160692 |
| WPE 35 | Sample 1 | Whey protein concentrate with | Origin Nestlé; Batch 35179G |
| | Sample 2 | 35% protein | Origin Nestlé; Batch 35304C |
| | Sample 3 | | Origin Nestlé; Batch 353251G |
| | Sample 4 | | Origin Nestlé; Batch 35254G |
| | Sample 5 | | Origin Nestlé; Batch 997283 |
| | Sample 6 | | Origin Nestlé; Batch 0113515603 |
| | Sample 7 | | Origin Nestlé; Batch 41521234 |
| | Sample 8 | | Origin Nestlé; Batch RN580895 |
| | Sample 9 | | Origin Nestlé; Batch 40967009 |
| | Sample 10 | | Origin Nestlé; Batch 40967519 |
| | Sample 11-14 | | Origin: Nestlé; Batch 35095H |
| | Sample 15-18 | | Origin: Nestlé; Batch 35156H |
| | Sample 19-22 | | Origin: Nestlé; Batch 35148 H |
| Skim milk | Sample 1 | | Origin Nestlé; Batch 1118266G |
| powder | Sample 2 | | Origin Nestlé; Batch 426511P301 |
| | Sample 3 | | Origin Nestlé; Batch 6060067155 |
| | Sample 4 | | Origin Nestlé; Batch 1118194G |
| | Sample 5 | | Origin Nestlé; Batch 1118194G |
| | Sample 6 | | Origin Nestlé; Batch 1082D083 |
| | Sample 7 | | Origin Nestlé; Batch 2605411 |
| | Sample 8 | | Origin Nestlé; Batch 1025255G |
| | Sample 9 | | Origin Nestlé; Batch 1011522630 |
| | Sample 10 | | Origin Nestlé; Batch 1118195G |
| | Sample 11-14 | | Origin: Nestlé; Batch 108231295 |
| | Sample 15-18 | | Origin: Nestlé; Batch 6060067140 |
| | Sample 19-22 | | Origin: Nestlé; Batch 6060067155 |

A calibration standard was prepared as follows: A 10 mg/mL solution of OPN was prepared in accordance with the COA value, i.e. OPN of protein purity 76.32% purity (76.71% @ N=6.25×99.5% confidence), therefore 1.31 g of OPN raw material made up to 100 mL=10 mg/mL OPN solution.

The analysis was performed in accordance with the method described herein. An amount of 1.0 g of the sample to be analysed was introduced in a 50 mL flask. The sample was solubilized in urea and ABC buffer and then diluted to 50 mL. The sample was then heated to 60° C. for 30 minutes under stirring and were shaken intermittently.

Then 500 μL of each sample was placed in an Eppendorf tube. An amount of 40 μL of DTT was added, before heating to 60° C. for 30 minutes and then cooling to room temperature. Then 40 μL of IAA was added and the sample was placed in the dark at room temperature for 30 minutes.

An amount of 50 μL of the sample was then placed in another Eppendorf tube and diluted with 150 μL ABC buffer. An amount of 100 μL of trypsin was then added and the sample was heated as 37° C. and incubated for 2 hours. After the incubation, 50 μL of FA solution was added.

An amount of 100 μL of the obtained solution was placed into a vial insert and 100 μL of IS were added.

The sample was then subjected to LC-MS/MS analysis. The conditions of the HPLC experiment are provided in Table 2 below and the conditions of the MS analysis are provided in Table 3.

TABLE 2
Conditions of the HPLC analysis

| HPLC conditions | Description |
|---|---|
| Column | Agilent Zorbax SB-C18 2.1 × 100 mm |
| | 1.8 micron |
| Mobile Phase A (MP A) | 0.1% (v/v) FA in water (1.9.1) |
| Mobile Phase B (MP B) | 0.1% (v/v) FA in acetonitrile (1.9.2) |
| Flow rate | 0.2 mL/min |
| Column Temperature | 40° C. |
| Gradient | O min - 10% B, 5 min - 15% B, |
| | 10 min - 20% B, 12 min - 20% |
| | B, 20 min - 30% B, 22 min - 100% |
| | B, 23 min - 100% B, 23.01 min - 10% |
| | B, 33 min - 10% B. |
| Injection volume | 20 μL. |
| Autosampler | 5° C. |

TABLE 3
Conditions of the MS analysis

| MS parameter | Description | |
|---|---|---|
| Polarity | Positive | |
| Gas temperature | 210° C. | |
| Gas flow | 11 | L/min |
| Nebuliser | 20 | psi |
| Sheath gas temp | 250° C. | |
| Sheath gas flow | 11 | L/min |
| Capillary | 3000 | V |
| Nozzle voltage | 500 | V |
| High pressure RF | 110 | V |
| Low pressure RF | 60 | V |

The results of the LC-MS/MS analysis are provided in Table 4 below.

TABLE 4
Amount of osteopontin present in the
different test samples and in the control

| | Skim milk | | alpha-lac |
|---|---|---|---|
| Sample | powder | WPE 35 | enriched WPE |
| 1 | 57.20 | 171.00 | 712.80 |
| 2 | 58.80 | 160.50 | 596.20 |
| 3 | 67.90 | 150.50 | 653.20 |
| 4 | 64.80 | 144.00 | 654.40 |
| 5 | 51.20 | 159.50 | 687.80 |
| 6 | 25.40 | 196.70 | 700.20 |
| 7 | 50.20 | 135.90 | 625.40 |
| 8 | 58.10 | 155.00 | 559.20 |
| 9 | 64.20 | 204.70 | 597.60 |
| 10 | 56.50 | 151.10 | 578.40 |
| 11 | 87.50 | 185.00 | 1056.00 |
| 12 | 88.75 | 185.75 | 1049.00 |
| 13 | 89.00 | 185.75 | 1049.00 |
| 14 | 89.25 | 186.25 | 1044.00 |
| 15 | 88.25 | 186.75 | 1088.00 |
| 16 | 87.50 | 186.50 | 1084.00 |
| 17 | 85.75 | 184.50 | 1060.00 |
| 18 | 84.75 | 184.50 | 1062.00 |
| 19 | 73.25 | 165.00 | 801.00 |
| 20 | 72.75 | 165.00 | 889.00 |
| 21 | 71.75 | 160.25 | 876.00 |
| 22 | 69.00 | 160.25 | 866.00 |
| Average | 70.08 | 171.11 | 831.33 |
| Std Dev | 16.80 | 18.38 | 199.80 |
| RSD | 23.98 | 10.74 | 24.03 |
| Min. | 25.40 | 135.90 | 559.20 |
| Max. | 89.25 | 204.70 | 1088.00 |

The α-lactalbumin enriched WPE thus had by far the highest amount of osteopontin compared to other samples.

α-Lac enriched whey ingredients can be produced by various processes, which are proprietary to each manufacturer; these processes can differ significantly (O'Regan, Ennis & Mulvihill; Milk proteins; In: Phillips and Williams, Handbook of hydrocolloids, 2^{nd} Ed. 2009, pp. 298-358). It is inferred that the production process of α-lac enriched WPE of Sample 1 effectively enriches the osteopontin content of the WPE.

### EXAMPLE 2

Examples of synthetic nutritional compositions (infant formulas) in accordance with the invention is set out in Tables 5 to 8.

TABLE 5
composition of Infant Formula A

| | UNITS | Amount in Infant |
|---|---|---|
| NUTRIENT | per Litre | Formula A |
| Energy | kcal | 662.00 |
| Energy | kJ | 2768.00 |
| Water/Moisture | g | 903.00 |
| Ash | g | 5.27 |
| Protein | | |
| Protein | g | 13.40 |
| 65% Whey | g | 8.70 |
| Alpha-lactalbumin | g | 2.3 stemming from 9.5 g |
| | | of alpha-lactalbumin |
| | | enriched WPE according |
| | | to the inventention |
| | | (Sample 1 of Example 1). |
| 35% Casein | g | 4.70 |
| Osteopontin | mg | 89.30 |
| Carbohydrates | | |
| Available | g | 67.20 |
| Carbohydrates | | |
| Carbohydrate | g | 75.00 |
| of which lactose | g | 66.10 |
| of which sugars | g | 67.20 |
| Fiber | g | 7.80 |
| Oligosaccharides | g | 7.80 |
| Lipids | | |
| Total Fat | g | 36.00 |
| Linoleic Acid | mg | 5200.00 |
| Linolenic Acid | mg | 420.00 |
| linoleic:alpha- | ratio | 12.40 |
| linolenic acid ratio | | |
| ARA | mg | 126.00 |
| DHA | mg | 126.00 |
| ARA/DHA | ratio | 1.00 |
| 1-3-Dioleoyl-2- | g | 5.32 |
| palmitoyl triglyceride | | |
| Vitamins | | |
| Vitamin A (Retinol) | mcg RE | 724.00 |
| Beta-carotene | mcg | 150.00 |
| Vitamin D | mcg D | 9.60 |
| (Cholecalciferol) | | |
| Vitamin E (TE) | mg | 8.72 |
| Vitamin K | mcg | 53.60 |
| Vitamin B1 (Thiamine) | mg | 1.25 |
| Vitamin B2 (Riboflavin) | mg | 1.11 |
| Vitamin B6 (Pyridoxine) | mg | 0.75 |
| Vitamin B12 | mcg | 2.30 |
| (Cyanocobalamin) | | |
| Niacin | mg | 6.25 |
| Folic Acid | mcg | 100.00 |
| Pantothenic Acid | mg | 3.75 |
| Biotin | mcg | 25.00 |
| Vitamin C | mg | 90.00 |
| (Ascorbic acid) | | |
| Minerals and | | |
| Trace Elements | | |
| Calcium | mg | 428.00 |
| Phosphorus | mg | 240.00 |
| Ca:P | ratio | 1.78 |
| Magnesium | mg | 48.00 |
| Iron | mg | 8.00 |
| Zinc | mg | 6.00 |
| Manganese | mcg | 50.00 |
| Copper | mg | 0.51 |
| Iodine | mcg | 100.00 |
| Sodium | mg | 188.00 |
| Potassium | mg | 650.00 |
| Chloride | mg | 433.00 |
| Selenium | mcg | 20.60 |
| Other substances | | |
| Choline | mg | 164.00 |
| Inositol | mg | 45.00 |
| Taurine | mg | 47.00 |
| L-Carnitine | mg | 10.00 |
| Lutein | mcg | 116.00 |
| Nucleotides (Total) | mg | 26.00 |
| CMP | mg | 13.00 |
| UMP | mg | 5.00 |
| AMP | mg | 4.00 |
| GMP | mg | 2.00 |
| IMP | mg | 2.00 |

The composition may be for use in an infant of 0 to 6 months.

TABLE 6
composition of Infant Formula B

| | UNITS | Amount in Infant |
|---|---|---|
| NUTRIENT | per Litre | Formula B |
| Energy | kcal | 673.00 |
| Energy | kJ | 2826.00 |
| Water/Moisture | g | 898.00 |
| Ash | g | 6.53 |
| Protein | | |
| Protein | g | 21.50 |
| 40% Whey | g | 8.60 |
| Alpha-lactalbumin | g | 1.30 |
| 60% Casein | g | 12.90 |
| Osteopontin | g | 57.50 |
| Carbohydrates | | |
| Available | g | 75.50 |
| Carbohydrates | | |
| Carbohydrate | g | 83.30 |
| of which lactose | g | 75.50 |
| of which sugars | g | 75.50 |
| Fiber | g | 7.82 |
| Oligosaccharide | g | 7.82 |
| Lipids | | |
| Total Fat | g | 30.00 |
| Linoleic Acid | mg | 4350.00 |
| Linolenic Acid | mg | 430.00 |
| linoleic:alpha- | ratio | 10.10 |
| linolenic acid ratio | | |
| ARA | mg | 115.00 |
| DHA | mg | 115.00 |
| ARA/DHA | ratio | 1.00 |
| 1-3-Dioleoyl-2- | g | 5.80 |
| palmitoyl triglyceride | | |
| Vitamins | | |
| Vitamin A (Retinol) | mcg RE | 590.00 |
| Beta-carotene | mcg | 150.00 |
| Vitamin D | mcg D | 11.20 |
| (Cholecalciferol) | | |
| Vitamin E (TE) | mg | 6.71 |
| Vitamin K | mcg | 44.00 |
| Vitamin B1 (Thiamine) | mcg | 637.00 |
| Vitamin B2 (Riboflavin) | mg | 1.75 |
| Vitamin B6 (Pyridoxine) | mg | 0.50 |
| Vitamin B12 | mcg | 1.80 |
| (Cyanocobalamin) | | |
| Niacin | mg | 5.32 |
| Folic Acid | mcg | 134.00 |
| Pantothenic Acid | mg | 3.50 |
| Biotin | mcg | 14.90 |
| Vitamin C | mg | 90.00 |
| (Ascorbic acid) | | |
| Minerals and | | |
| Trace Elements | | |
| Calcium | mg | 759.00 |
| Phosphorus | mg | 510.00 |
| Ca:P | ratio | 1.48 |
| Magnesium | mg | 85.00 |
| Iron | mg | 12.00 |
| Zinc | mg | 6.00 |
| Manganese | mcg | 349.00 |
| Copper | mg | 0.29 |
| Iodine | mcg | 100.00 |
| Sodium | mg | 335.00 |
| Potassium | mg | 900.00 |
| Chloride | mg | 760.00 |
| Selenium | mcg | 20.00 |
| Other substances | | |
| Choline | mg | 203.00 |
| Inositol | mg | 56.00 |
| Taurine | mg | 47.00 |
| Lutein | mcg | 235.00 |
| Nucleotides (Total) | mg | 26.00 |
| CMP | mg | 13.00 |
| UMP | mg | 5.00 |
| AMP | mg | 4.00 |
| GMP | mg | 2.00 |
| IMP | mg | 2.00 |

The composition may be for use in an infant of 6 to 12 months

TABLE 7
composition of Infant Formula C

| | UNITS | Amount in Infant |
|---|---|---|
| NUTRIENT | per Litre | Formula C |
| Energy | kcal | 747.00 |
| Energy | kJ | 3153.00 |
| Water/Moisture | g | 871.00 |
| Ash | g | 7.79 |
| Protein | | |
| Protein | g | 23.50 |
| 40% Whey | g | 9.40 |
| Alpha-lactalbumin | g | 1.25 |
| 60% Casein | g | 14.10 |
| Osteopontin | mg | 62.90 |
| Carbohydrates | | |
| Available | g | 111.00 |
| Carbohydrates | | |
| Carbohydrate | g | 104.00 |
| Fiber | g | 7.82 |
| Oligosaccharides | g | 7.82 |
| Lipids | | |
| Total Fat | g | 25.00 |
| Linoleic Acid | mg | 5493.00 |
| Linolenic Acid | mg | 550.00 |
| linoleic:alpha- | ratio | 10.00 |
| linolenic acid ratio | | |
| ARA | mg | 25.90 |
| DHA | mg | 96.70 |
| ARA/DHA | ratio | 0.27 |
| 1-3-Dioleoyl-2- | g | 5.20 |
| palmitoyl triglyceride | | |
| Vitamins | | |
| Vitamin A (Retinol) | mcg RE | 565.00 |
| Beta-carotene | mcg | 150.00 |
| Vitamin D | mcg D | 13.20 |
| (Cholecalciferol) | | |
| Vitamin E (TE) | mg | 7.45 |
| Vitamin K | mcg | 91.30 |
| Vitamin B1 (Thiamine) | mg | 0.76 |
| Vitamin B2 (Riboflavin) | mg | 1.25 |
| Vitamin B6 (Pyridoxine) | mg | 0.63 |
| Vitamin B12 | mcg | 2.60 |
| (Cyanocobalamin) | | |
| Niacin | mg | 6.00 |
| Folic Acid | mcg | 188.00 |
| Pantothenic Acid | mg | 5.03 |
| Biotin | mcg | 20.00 |
| Vitamin C | mg | 120.00 |
| (Ascorbic acid) | | |
| Minerals and | | |
| Trace Elements | | |
| Calcium | mg | 827.00 |
| Phosphorus | mg | 555.00 |
| Ca:P | ratio | 1.50 |
| Magnesium | mg | 65.00 |
| Iron | mg | 12.00 |
| Zinc | mg | 7.06 |
| Manganese | mcg | 804.00 |
| Copper | mg | 0.35 |
| Iodine | mcg | 125.00 |
| Sodium | mg | 325.00 |
| Potassium | mg | 1200.00 |
| Chloride | mg | 740.00 |
| Selenium | mcg | 25.00 |
| Other substances | | |
| Choline | mg | 240.00 |
| Inositol | mg | 56.00 |
| Taurine | mg | 68.00 |
| Lutein | mcg | 286.00 |
| Nucleotides (Total) | mg | 26.00 |
| CMP | mg | 13.00 |
| UMP | mg | 5.00 |
| AMP | mg | 4.00 |
| GMP | mg | 2.00 |
| IMP | mg | 2.00 |

The composition may be for use in a child of 1 to 3 years

TABLE 8
composition of Infant Formula D

| | UNITS | Amount in Infant |
|---|---|---|
| NUTRIENT | per Litre | Formula D |
| Energy | kcal | 750.00 |
| Energy | kJ | 3167.00 |
| Water/Moisture | g | 850.00 |
| Ash | g | 8.53 |
| Protein | | |
| Protein | g | 28.60 |
| 40% Whey | g | 11.50 |
| as alpha-lactalbumin | g | 1.59 |
| 60% Casein | g | 17.20 |
| Osteopontin | mg | 80.50 |
| Carbohydrates | g | 102.00 |
| Available Carbohydrates | g | 96.00 |
| Fiber | g | 5.92 |
| Oligosaccharide | g | 5.92 |
| Lipids | | |
| Total Fat | g | 27.00 |
| Linoleic Acid | mg | 7100.00 |
| Linolenic Acid | mg | 700.00 |
| linoleic:alpha- | ratio | 10.10 |
| linolenic acid ratio | | |
| ARA | mg | 19.70 |
| DHA | mg | 73.50 |
| ARA/DHA | ratio | 0.27 |
| 1-3-Dioleoyl-2- | g | 5.14 |
| palmitoyl triglyceride | | |
| Vitamins | | |
| Vitamin A (Retinol) | mcg RE | 378.00 |
| Beta-carotene | mcg | 95.40 |
| Vitamin D | mcg D | 6.65 |
| (Cholecalciferol) | | |
| Vitamin E (TE) | mg | 6.61 |
| Vitamin K | mcg | 56.80 |
| Vitamin B1 (Thiamine) | mg | 0.59 |
| Vitamin B2 (Riboflavin) | mg | 0.91 |
| Vitamin B6 (Pyridoxine) | mg | 0.50 |
| Vitamin B12 | mcg | 2.20 |
| (Cyanocobalamin) | | |
| Niacin | mg | 5.15 |
| Folic Acid | mcg | 66.60 |
| Pantothenic Acid | mg | 1.90 |
| Biotin | mcg | 15.10 |
| Vitamin C | mg | 36.40 |
| (Ascorbic acid) | | |
| Minerals and | | |
| Trace Elements | | |
| Calcium | mg | 790.00 |
| Phosphorus | mg | 640.00 |
| Ca:P | ratio | 1.25 |
| Magnesium | mg | 89.40 |
| Iron | mg | 7.73 |
| Zinc | mg | 0.77 |
| Manganese | mcg | 1200.00 |
| Copper | mg | 0.63 |
| Iodine | mcg | 75.80 |
| Sodium | mg | 393.00 |
| Potassium | mg | 1515.00 |
| Chloride | mg | 758.00 |
| Selenium | mcg | 18.90 |
| Other substances | | |
| Choline | mg | 227.00 |
| Inositol | mg | 34.10 |
| Taurine | mg | 37.80 |
| Lutein | mg | 210.00 |

The composition may be for use in a child of 3 to 8 years

### EXAMPLE 3

Six different samples were prepared as described in example 1 for each of the infant formulae described in Example 2 (Infant formulae A to D). The amount of osteopontin in each sample was analyzed using the method described in Example 1. The results of the osteopontin analysis are provided in Table 9 below.

TABLE 9
Amounts of osteopontin [mg/100 g]
found in Infant formulae A to D

| | Infant | Infant | Infant | Infant |
|---|---|---|---|---|
| | Formula | Formula | Formula | Formula |
| | A | B | C | D |
| sample 1 | 66.2 | 31.6 | 27.8 | 32.7 |
| sample 2 | 66.3 | 32.2 | 29.4 | 32.5 |
| sample 3 | 67.0 | 31.3 | 29.6 | 34.2 |
| sample 4 | 66.2 | 31.3 | 28.3 | 32.5 |
| sample 5 | 66.6 | 32.6 | 27.7 | 32.4 |
| sample 6 | 66.8 | 31.9 | 28.6 | 34.2 |
| Average | 66.5 | 31.8 | 28.6 | 33.1 |

These results suggest that osteopontin contained in the α-lac enriched WPE was not substantially degraded during the manufacturing processes used to prepare infant formulae A to D.

### EXAMPLE 4

Examples of synthetic nutritional compositions (infant formulas) in accordance with the invention is set out in Tables 9 to 12.

TABLE 10
composition of Infant Formula E

| | UNITS | Amount in Infant |
|---|---|---|
| NUTRIENT | Per 100 g | Formula E |
| Energy | kcal | 514.00 |
| Energy | kJ | 2148.00 |
| Water/Moisture | g | 3.00 |
| Ash | g | 2.57 |
| Protein | | |
| Protein | g | 10.40 |
| 65% Whey | g | 6.75 |
| Alpha-lactalbumin | g | 1.78 |
| 35% Casein | g | 3.64 |
| Osteopontin | mg | 71.80 |
| Carbohydrates | | |
| Available | G | 53.30 |
| Carbohydrates | | |
| Carbohydrate | G | 53.30 |
| of which lactose | G | 53.30 |
| of which sugars | G | 53.30 |
| Soluble Dietary Fiber | G | 3.88 |
| (as oligofructose) | | |
| Lipids | | |
| Total Fat | G | 27.90 |
| Linoleic Acid | mg | 4031.00 |
| Linolenic Acid | mg | 326.00 |
| linoleic:alpha- | ratio | 12.40 |
| linolenic acid ratio | | |
| ARA | Mg | 95.30 |
| DHA | Mg | 95.30 |
| ARA/DHA | ratio | 1.00 |
| Vitamins | | |
| Vitamin A (Retinol) | mcg RE | 563.00 |
| Beta-carotene | mcg | 116.00 |
| Vitamin D | mcg D | 9.30 |
| (Cholecalciferol) | | |
| Vitamin E (TE) | mg | 5.72 |
| Vitamin K | mcg | 50.00 |
| Vitamin B1 (Thiamine) | mg | 0.78 |
| Vitamin B2 (Riboflavin) | mg | 0.85 |
| Vitamin B6 (Pyridoxine) | mg | 0.43 |
| Vitamin B12 | mcg | 1.40 |
| (Cyanocobalamin) | | |
| Niacin | mg | 3.88 |
| Folic Acid | mcg | 82.90 |
| Pantothenic Acid | mg | 2.70 |
| Biotin | mcg | 15.50 |
| Vitamin C | mg | 69.80 |
| (Ascorbic acid) | | |
| Minerals and | | |
| Trace Elements | | |
| Calcium | mg | 330.00 |
| Phosphorus | mg | 180.00 |
| Ca:P | ratio | 1.83 |
| Magnesium | mg | 34.90 |
| Iron | mg | 6.20 |
| Zinc | mg | 4.65 |
| Manganese | mcg | 38.80 |
| Copper | mg | 0.33 |
| Iodine | mcg | 77.50 |
| Sodium | mg | 124.00 |
| Potassium | mg | 504.00 |
| Chloride | mg | 336.00 |
| Selenium | mcg | 10.90 |
| Other substances | | |
| Choline | mg | 124.00 |
| Inositol | mg | 34.90 |
| Taurine | mg | 36.40 |
| L-Carnitine | mg | 7.75 |
| Lutein | mg | 0.09 |
| Nucleotides (Total) | mg | 20.20 |
| CMP | mg | 10.10 |
| UMP | mg | 3.88 |
| AMP | mg | 3.10 |
| GMP | mg | 1.55 |
| IMP | mg | 1.55 |

The composition may be for use in an infant of 0 to 6 months.

TABLE 11
composition of Infant Formula F

| | UNITS | Amount in Infant |
|---|---|---|
| NUTRIENT | per 100 g | Formula F |
| Energy | kcal | 468.00 |
| Energy | kJ | 1963.00 |
| Water/Moisture | g | 2.00 |
| Ash | g | 3.23 |
| Protein | | |
| Protein | g | 14.90 |
| 40% Whey | g | 5.96 |
| Alpha-lactalbumin | g | 1.19 g |
| 60% Casein | g | 8.94 |
| Osteopontin | mg | 53.40 |
| Carbohydrates | | |
| Available Carbohydrates | g | 53.10 |
| of which lactose | g | 53.10 |
| of which sugars | g | 53.10 |
| Soluble Dietary Fiber | g | 3.50 |
| (as oligofructose) | | |
| Lipids | | |
| Total Fat | g | 21.00 |
| Linoleic Acid | mg | 3147.00 |
| Linolenic Acid | mg | 259.00 |
| linoleic:alpha- | ratio | 12.20 |
| linolenic acid ratio | | |
| ARA | mg | 78.70 |
| DHA | mg | 78.70 |
| ARA/DHA | ratio | 1.00 |
| Sphingomeylin | mg | 42.90 |
| Phospholipids | mg | 214.00 |
| Vitamins | | |
| Vitamin A (Retinol) | mcg RE | 507.00 |
| Beta-carotene | mcg | 105.00 |
| Vitamin D | mcg D | 7.87 |
| (Cholecalciferol) | | |
| Vitamin E (TE) | mg | 4.88 |
| Vitamin K | mcg | 38.50 |
| Vitamin B1 (Thiamine) | mcg | 357.00 |
| Vitamin B2 (Riboflavin) | mcg | 979.00 |
| Vitamin B6 (Pyridoxine) | mcg | 280.00 |
| Vitamin B12 | mcg | 1.07 |
| (Cyanocobalamin) | | |
| Niacin | mg | 2.80 |
| Folic Acid | mcg | 55.90 |
| Pantothenic Acid | mg | 2.45 |
| Biotin | mcg | 9.09 |
| Vitamin C | mg | 62.90 |
| (Ascorbic acid) | | |
| Minerals and | | |
| Trace Elements | | |
| Calcium | mg | 540.00 |
| Phosphorus | mg | 330.00 |
| Ca:P | ratio | 1.64 |
| Magnesium | mg | 54.00 |
| Iron | mg | 8.39 |
| Zinc | mg | 4.20 |
| Manganese | mcg | 245.00 |
| Copper | mcg | 203.00 |
| Iodine | mcg | 46.80 |
| Sodium | mg | 170.00 |
| Potassium | mg | 630.00 |
| Chloride | mg | 420.00 |
| Selenium | mcg | 18.50 |
| Other substances | | |
| Choline | mg | 140.00 |
| Inositol | mg | 31.50 |
| Taurine | mg | 32.90 |
| Lutein | mcg | 162.00 |
| Nucleotides (Total) | mg | 18.20 |
| CMP | mg | 9.09 |
| UMP | mg | 3.50 |
| AMP | mg | 2.80 |
| GMP | mg | 1.40 |
| IMP | mg | 1.40 |

The composition may be for use in an infant of 6 to 12 months

TABLE 12
composition of Infant Formula G

| | UNITS | Amount in Infant |
|---|---|---|
| NUTRIENT | Per 100 g | Formula G |
| Energy | kcal | 428.00 |
| Energy | kJ | 1800.00 |
| Water/Moisture | g | 3.00 |
| Ash | g | 4.60 |
| Protein | | |
| Protein | g | 13.70 |
| 40% Whey | g | 5.48 |
| Alpha-lactalbumin | g | 0.97 |
| 60% Casein | g | 8.22 |
| Osteopontin | mg | 46.20 |
| Carbohydrates | | |
| Available Carbohydrates | g | 58.80 |
| Soluble Dietary Fiber | g | 3.00 |
| (as oligofructose) | | |
| Lipids | | |
| Total Fat | g | 14.60 |
| Linoleic Acid | mg | 3250.00 |
| Linolenic Acid | mg | 320.00 |
| linoleic:alpha- | ratio | 10.20 |
| linolenic acid ratio | | |
| ARA | mg | 14.80 |
| DHA | mg | 55.10 |
| ARA/DHA | ratio | 0.27 |
| Phospholipids | g | 0.17 |
| Sphingomyelin | mg | 34.30 |
| Vitamins | | |
| Vitamin A (Retinol) | mcg RE | 525.00 |
| Beta-carotene | mcg | 85.20 |
| Vitamin D | mcg D | 8.25 |
| (Cholecalciferol) | | |
| Vitamin E (TE) | mg | 3.40 |
| Vitamin K | mcg | 39.00 |
| Vitamin B1 (Thiamine) | mg | 0.35 |
| Vitamin B2 (Riboflavin) | mg | 0.57 |
| Vitamin B6 (Pyridoxine) | mg | 0.28 |
| Vitamin B12 | mcg | 1.20 |
| (Cyanocobalamin) | | |
| Niacin | mg | 3.40 |
| Folic Acid | mcg | 56.80 |
| Pantothenic Acid | mg | 2.30 |
| Biotin | mcg | 9.10 |
| Vitamin C | mg | 68.20 |
| (Ascorbic acid) | | |
| Minerals and | | |
| Trace Elements | | |
| Calcium | mg | 520.00 |
| Phosphorus | mg | 310.00 |
| Ca:P | ratio | 1.68 |
| Magnesium | mg | 41.40 |
| Iron | mg | 7.96 |
| Zinc | mg | 2.80 |
| Manganese | mcg | 227.00 |
| Copper | mg | 0.26 |
| Iodine | mcg | 85.20 |
| Sodium | mg | 180.00 |
| Potassium | mg | 775.00 |
| Chloride | mg | 399.00 |
| Selenium | mcg | 11.40 |
| Other substances | | |
| Choline | mg | 136.00 |
| Inositol | mg | 28.40 |
| Taurine | mg | 26.70 |
| Lutein | mg | 0.16 |
| Nucleotides (Total) | mg | 14.80 |
| CMP | mg | 7.39 |
| UMP | mg | 2.84 |
| AMP | mg | 2.27 |
| GMP | mg | 1.14 |
| IMP | mg | 1.14 |

The composition may be for use in a child of 1 to 3 years

TABLE 13
composition of Infant Formula H

| | UNITS | Amount in Infant |
|---|---|---|
| NUTRIENT | per 100 g | Formula H |
| Energy | kcal | 442.00 |
| Energy | kJ | 1858.00 |
| Water/Moisture | g | 3.00 |
| Ash | g | 5.06 |
| Protein | | |
| Protein | g | 17.00 |
| 40% Whey | g | 6.80 |
| as alpha-lactalbumin | mg | 901.00 |
| 60% Casein | g | 10.20 |
| Osteopontin | mg | 49.50 |
| Carbohydrates | | |
| Available Carbohydrates | g | 55.90 |
| Soluble Dietary Fiber | g | 3.02 |
| (as oligofructose) | | |
| Lipids | | |
| Total Fat | g | 16.00 |
| Linoleic Acid | mg | 3829.00 |
| Linolenic Acid | mg | 317.00 |
| linoleic:alpha- | ratio | 12.10 |
| linolenic acid ratio | | |
| ARA | mg | 11.70 |
| DHA | mg | 43.70 |
| ARA/DHA | ratio | 268.00 |
| Sphingomyelin | mg | 34.90 |
| Phospholipids | mg | 175.00 |
| Vitamins | | |
| Vitamin A (Retinol) | mcg RE | 242.00 |
| Beta-carotene | mcg | 56.80 |
| Vitamin D | mcg D | 4.05 |
| (Cholecalciferol) | | |
| Vitamin E (TE) | mg | 3.33 |
| Vitamin K | mcg | 33.80 |
| Vitamin B1 (Thiamine) | mcg | 327.00 |
| Vitamin B2 (Riboflavin) | mcg | 541.00 |
| Vitamin B6 (Pyridoxine) | mcg | 338.00 |
| Vitamin B12 | mcg | 1.35 |
| (Cyanocobalamin) | | |
| Niacin | mg | 3.06 |
| Folic Acid | mcg | 39.60 |
| Pantothenic Acid | mg | 1.22 |
| Biotin | mcg | 9.01 |
| Vitamin C | mg | 15.30 |
| (Ascorbic acid) | | |
| Minerals and | | |
| Trace Elements | | |
| Calcium | mg | 465.00 |
| Phosphorus | mg | 405.00 |
| Ca:P | ratio | 1.15 |
| Magnesium | mg | 53.20 |
| Iron | mg | 4.96 |
| Zinc | mg | 1.30 |
| Manganese | mcg | 714.00 |
| Copper | mcg | 374.00 |
| Iodine | mcg | 27.00 |
| Sodium | mg | 234.00 |
| Potassium | mg | 901.00 |
| Chloride | mg | 450.00 |
| Selenium | mcg | 3.11 |
| Other substances | | |
| Choline | mg | 135.00 |
| Inositol | mg | 21.60 |
| Taurine | mg | 26.10 |
| Lutein | mcg | 126.00 |

The composition may be for use in a child of 3 to 8 years

### EXAMPLE 5

The amount of osteopontin present in the infant formulae of Example 4 was determined as described in Example 1. The results are provided in Table 9 below.

TABLE 9
Amounts of osteopontin [mg/L]
found in Infant formulae E to H

| | Amount of |
|---|---|
| | osteopontin [mg/L] |
| Infant Formula E | 92.7 |
| Infant Formula F | 74.7 |
| Infant Formula G | 80.8 |
| Infant Formula H | 104.0 |

These results suggest that osteopontin contained in the α-lac enriched WPE was stable against degradation during the manufacturing processes used to prepare infant formulae A to D.

### CONCLUSION

The osteopontin levels found in commercially available dairy ingredients used for the manufacture of infant formula can vary, depending on their composition and the manufacturing processes used. This, in turn, affects the osteopontin content of subsequent formulations that use these ingredients. The possibility to enrich ingredients in useful nutrients, such as osteopontin, while enriching other key components, such as high-quality protein like α-lactalbumin, is an area with significant potential for further development. Enriching existing ingredients in osteopontin may negate the necessity to add additional exogenous sources, while still providing infant nutritional products with osteopontin levels similar to those in human milk. One of the primary advantages of supplementing osteopontin levels through osteopontin-enriched, high-protein ingredients such as α-lac is that levels similar to those in human milk can be achieved for both α-lactalbumin and osteopontin. This can be accomplished in a single ingredient and without additional need for fortification of either component. Use of alternative α-lac-enriched WPE powders can provide the desired protein profile but may lack additional benefits such as increased osteopontin levels.

1. Method for producing an α-lactalbumin enriched whey protein extract as a source of osteopontin in a synthetic nutritional composition for an infant or child wherein, comprising:
a. acidifying a whey protein product to pH 4 or below
b. forming a low calcium whey protein product by concentrating the proteins in the acidified whey protein until the calcium to protein ratio is less than about 0.001 and,
c. precipitating α-lactalbumin from the low-calcium whey protein product, wherein the precipitating step includes the sub-steps of:
diluting the low-calcium whey protein product,
adjusting the pH of the diluted low-calcium whey protein product to between 4 and 5 to form a precipitate and soluble proteins, and
separating the precipitate proteins from the soluble proteins.

2. Method as defined in claim 1, and wherein the α-lactalbumin enriched WPE is added to the composition in an effective amount sufficient to ensure that the synthetic nutritional composition has a final concentration of osteopontin in a range found in human breast milk.

3. Method according to claim 2 wherein the α-lactalbumin enriched whey protein extract is also used to optimise the concentration of α-lactalbumin in the synthetic nutritional composition for an infant or child, and wherein the α-lactalbumin enriched WPE is added to the composition in an effective amount sufficient to provide α-lactalbumin in one of the ranges found in human breast milk.

4. A synthetic nutritional composition for an infant or child comprising an α-lactalbumin enriched whey protein extract produced by a source of osteopontin in a synthetic nutritional composition for an infant or child wherein, comprising:
a. acidifying a whey protein product to pH 4 or below
b. forming a low calcium whey protein product by concentrating the proteins in the acidified whey protein until the calcium to protein ratio is less than about 0.001 and,
c. precipitating α-lactalbumin from the low-calcium whey protein product, wherein the precipitating step includes the sub-steps of:
diluting the low-calcium whey protein product,
adjusting the pH of the diluted low-calcium whey protein product to between 4 and 5 to form a precipitate and soluble proteins, and
separating the precipitate proteins from the soluble proteins wherein the synthetic nutritional composition comprises the α-lactalbumin enriched WPE in a concentration in a range of 0.8 to 8 g/L.

5. A synthetic nutritional composition for an infant or child according to claim 4 wherein the composition is an infant formula comprising 4 to 5 g/L of the α-lactalbumin enriched WPE.

6. A synthetic nutritional composition for an infant or child according to claim 4 wherein the composition is an infant formula comprising 4 to 5 g/L of the α-lactalbumin enriched WPE and wherein the composition is formulated for a child of 13 to 36 months of age.

7. A synthetic nutritional composition for an infant or child according to claim 6 wherein the composition is an infant formula comprising 0.5 to 1.5 g/L of the α-lactalbumin enriched WPE and wherein the composition is preferably formulated for a child of 3 to 8 years of age.

8. A synthetic nutritional composition for an infant or child according to claim 4 wherein the osteopontin concentration in the composition is at least 10 mg/L.

9. A synthetic nutritional composition for an infant or child according to claim 4 wherein the synthetic nutritional composition for an infant or child is a composition for consumption by infants either alone or in combination with human breast milk and is preferably an infant formula or human breast milk fortifier.

10. A method to promote and/or optimise the growth, optimize immune defense and/or the development in an infant or child to whom it is administered comprising the steps of administering a composition produced by an α-lactalbumin enriched whey protein extract as a source of osteopontin in a synthetic nutritional composition for an infant or child wherein, comprising:
a. acidifying a whey protein product to pH 4 or below
b. forming a low calcium whey protein product by concentrating the proteins in the acidified whey protein until the calcium to protein ratio is less than about 0.001 and,
c. precipitating α-lactalbumin from the low-calcium whey protein product, wherein the precipitating step includes the sub-steps of:
diluting the low-calcium whey protein product,
adjusting the pH of the diluted low-calcium whey protein product to between 4 and 5 to form a precipitate and soluble proteins, and
separating the precipitate proteins from the soluble proteins to the infant or child.

11-14. (canceled)
